(19) United States
(12) Patent Application Publication
(10) Pub. No.: US 2006/0086266 A1
(43) Pub. Date: Apr. 27, 2006

(54) Embossing unit and relative production method

(76) Inventor: Mario Spatafora, Granarolo (IT)

Correspondence Address: HARNESS, DICKEY & PIERCE, P.L.C., P.O. BOX 8910, RESTON, VA, 20195, US

(21) Appl. No.: 11/249,725

(22) Filed: Oct. 14, 2005

(30) Foreign Application Priority Data
Oct. 21, 2004 (IT) BO2004A 000652

(51) Int. Cl. B44B 5/00

(52) U.S. Cl. 101/3.1

(57) ABSTRACT

In an embossing unit, sheet material is fed between a first and at least one second embossing roller rotating in opposite direction and having first and second outer embossing tips respectively, and at least the first embossing roller has a metal core covered with a ceramic cylindrical jacket connected integrally to the metal core and having the first embossing tips on the outside; the first embossing roller being angularly integral with at least one first gear which meshes with a corresponding second gear angularly integral with the second embossing roller; and angular connection of the first gear to the first embossing roller being adjusted micrometrically to time the two embossing rollers with respect to each other, so that, in use, the first embossing tips are maintained at all times in a position meshing with the second embossing tips.

The present invention relates to a method of producing an embossing unit and an embossing unit so produced.

The present invention may be used to advantage for embossing strips (or sheets) of packing material (e.g. aluminium or foil, etc.) in the tobacco industry.

### PRIORITY STATEMENT

This application claims the benefit of Italian Patent Application No. BO2004A 000652, filed on Oct. 21, 2004, in the Italian Intellectual Property Office, the disclosure of which is incorporated herein in its entirety by reference.

### BACKGROUND OF THE INVENTION

More specifically, the present invention relates to an embossing unit of the type comprising a first and at least one second embossing roller rotating in opposite directions about a first and a second axis of rotation respectively, and having first and second outer embossing tips respectively; and at least one drive interposed between the embossing rollers and comprising a first and a second gear meshing with each other, coaxial with the first and second axis respectively, and angularly integral with the first and second embossing roller respectively.

An example of this type of embossing unit is disclosed in DE 10312323.

The embossing rollers of known embossing units of the type described above are normally made of metal alloy, and, though the metal embossing tips, given their elasticity, are capable of withstanding shock and slippage, they resist poorly to wear and call for frequent maintenance and reshaping.

Moreover, the wear is worsened by the poor intermeshing of the tips of the embossing rollers. In this regard it is important to point out that a proper intermeshing of the tips is not usually easily achievable. Please also note that embossing rollers, which have tips poorly intermeshed, have also the drawback of producing embossments of low quality.

### SUMMARY OF THE INVENTION

It is an object of the present invention to provide a method of producing an embossing unit and an embossing unit of the type described above, designed to eliminate, at least partially, the aforementioned drawbacks.

According to the present invention, there is provided a method of producing an embossing unit as claimed in the attached claims.

According to the present invention, there is provided an embossing unit, as claimed in the attached claims.

### BRIEF DESCRIPTION OF THE DRAWINGS

A non-limiting embodiment of the invention will be described by way of example with reference to the accompanying drawings, in which:

FIG. 1 shows a schematic functional view, with parts in section and parts removed for clarity, of a preferred embodiment of the embossing unit according to the present invention;

FIG. 2 shows a schematic view in perspective of one step in the assembly of the FIG. 1 embossing unit.

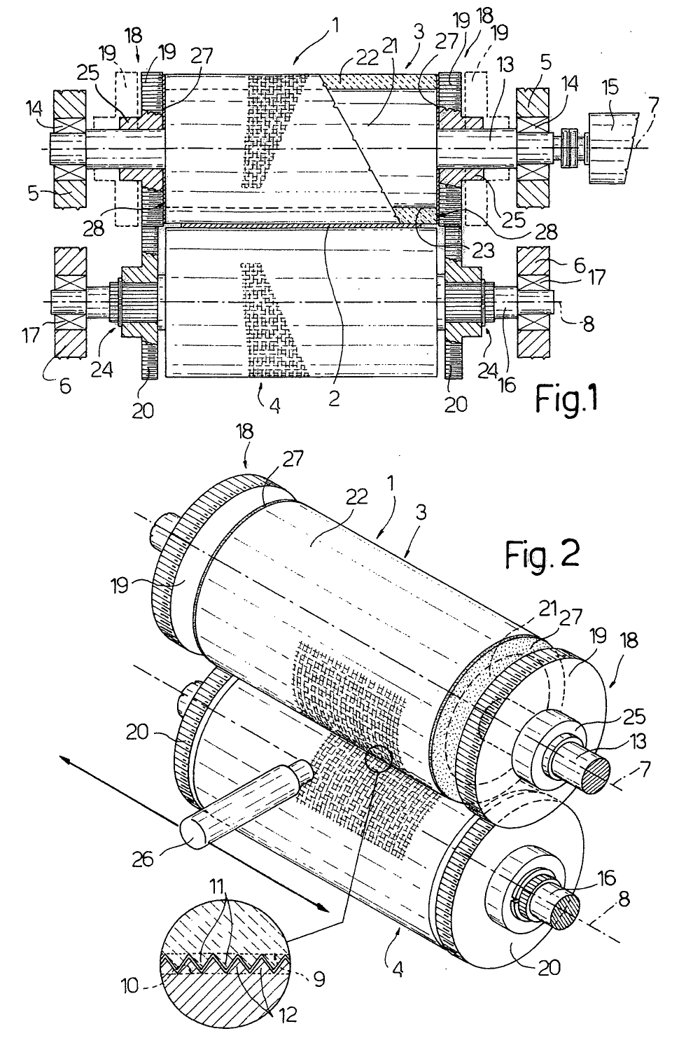

### DETAILED DESCRIPTION OF THE INVENTION

Number 1 in the accompanying drawings indicates as a whole an embossing unit for embossing a continuous strip (or a sheet) 2 of packing material (normally a strip or sheet of foil).

Embossing unit 1 comprises two embossing rollers 3 and 4, which are fitted to a frame 5 and a known supporting unit 6 respectively to rotate about respective axes 7 and 8, and have respective cylindrical pitch surfaces 9 and 10 (FIG. 2) having respective numbers of tips 11 and 12, which mesh along a pitch surface generating line of contact coplanar with axes 7 and 8 of embossing rollers 3 and 4.

More specifically, embossing roller 3 is a drive roller fitted to a respective shaft 13, which is coaxial with axis 7, is fitted to frame 5 with the interposition of bearings 14, and is connected angularly to the output of a motor 15 fixed to frame 5, to receive a given drive torque from motor 15.

Embossing roller 4 is fitted to a shaft 16 coaxial with axis 8 and supported for rotation by supporting unit 6 with the interposition of bearings 17, and is rotated by embossing roller 3 via two gear drives 18 located on opposite sides of embossing rollers 3 and 4, and each comprising a precision gear 19 coaxial with axis 7 and angularly integral with embossing roller 3, and a precision gear 20 coaxial with axis 8 and angularly integral with embossing roller 4.

In a variation not shown, only one drive 18 is employed.

In a further variation not shown, embossing roller 3 is connected to two or more embossing rollers 4, each of which is tangent to embossing roller 3 and defines, with embossing roller 3, a portion of a feed path of continuous strip 2.

Embossing roller 3 comprises a metal, preferably cylindrical core 21 integral with shaft 13 and coaxial with axis 7; and a cylindrical jacket 22 of ceramic material, which is formed either by coating metal core 21 with ceramic paste to form a layer which, when hardened, is machined to form pitch surface 9 and tips 11, or, preferably, as in the example shown, by fitting metal core 21 with a cylindrical ceramic sleeve, which is secured to metal core 21 by the interposition of a layer 23 of glue, normally a glue such as ARALDITE, and is subsequently machined to form tips 11 and pitch surface 9.

Embossing roller 4 may obviously be substantially similar to embossing roller 3, or, as in the example shown, a standard metal embossing roller, which is machined to form pitch surface 10 and tips 12.

In actual use, as shown in FIG. 2, continuous strip 2 is embossed by tips 11 and 12 meshing with one another as embossing rollers 3 and 4 rotate in opposite directions. Since, as stated, at least tips 11 are made of ceramic material, and any impact of tips 11 against tips 12—caused by improper meshing of tips 11 and 12 or angular slippage of embossing rollers 3 and 4 with respect to each other—could result in blunting of part of embossing roller 3, embossing unit 1 must be assembled extremely accurately to ensure perfect meshing of tips 11 and 12.

For this purpose, as shown in FIG. 2, when assembling embossing unit 1, gears 20 are each first fitted to shaft 16 by means, for example, of a precision splined coupling 24; and gears 19, which are each fitted inside with a cylindrical sleeve 25, are then fitted in angularly and axially movable manner to shaft 13. At this point, embossing rollers 3 and 4 are fitted to frame 5 and supporting unit 6 respectively, with gears 19 maintained outwards of respective gears 20; embossing rollers 3 and 4 are brought together; and embossing roller 4 is rotated, substantially manually or using an auxiliary micrometric feed device (known per se and not shown), about axis 8 to achieve substantially perfect meshing of tips 11 and 12, which is controlled by a precision optical detector 26, e.g. a microscope. At this point, embossing rollers 3 and 4 are locked angularly to relative shafts 13 and 16 and with respect to each other; the opposite axial ends of embossing roller 3 are coated with respective layers 27 of glue; and gears 19 are rotated about axis 7 and moved axially along shaft 13 to mesh with respective gears 20 and contact relative layers 27 of glue.

In one variation, gears 19 are glued to the opposite ends of roller 3 before this is fitted to roller 4. In which case, optical detector 26 provides for micrometrically timing the angular position of gears 19 with respect to the angular position of tips 11 before the glue dries.

In a further variation, layers 27 of glue are only applied to two annular end surfaces 28 of jacket 22.

Once layers 27 of glue dry, gears 19, by now integral with embossing roller 3, and in particular with jacket 22, mesh accurately with relative gears 20 and, in use, continue to maintain perfect meshing of tips 11 and 12 as originally set.

In view of the above, it is important to point out that micrometrically timing the angular position of gears 19 with respect to tips 11 it is possible to obtain substantially perfect meshing of tips 11 and 12 without risking to damage the relatively fragile cylindrical jacket 22.

According to a further embodiment, firstly gears 19 is made integral with respective shaft 13 and then the embossing roller 3 or the cylindrical ceramic sleeve, from which cylindrical jacket 22 is formed, is rotated about axis 7 with respect to gears 19 so as to achieve substantially perfect meshing of tips 11 and 12. At this point, the embossing roller 3 or the cylindrical ceramic sleeve is locked angularly to relative shaft 13.

As used herein, the term “micrometrically timing” means timing with high precision, preferably with the aid of a precision detecting means (in particular the optical detector 26) and/or with the aid of the above mentioned auxiliary micrometric feed device. More preferably the timing is obtained with micrometric precision (i.e. with a precision on the order of micrometers).

Although cylindrical jacket 22 of ceramic material is particularly easy to produce and shows many advantages in use (e.g. they are particularly light), according to further embodiments, cylindrical jacket 22 may be made of other suitable materials; in particular, other materials having relatively high resistance to wear and being relatively fragile may be used. Non-limiting examples of materials of which cylindrical jacket 22 may be made of are particular metal alloys (e.g. properly treated steel).

In the event both embossing rollers 3 and 4 have ceramic jackets, gears 20 substantially identical to gears 19 are employed, and are first meshed with relative gears 19, and then glued to embossing roller 4 at the same time gears 19 are glued to embossing roller 3.

In this case too, gears 20 may be glued to roller 4 regardless of the presence of roller 3 and with the aid of optical detector 26 to micrometrically time the angular position of gears 20 with respect to the angular position of tips 12 before the glue dries.

It should be pointed out that, though direct connection, by means of glue or similar, of gears 19 to the respective ends of embossing roller 3, and preferably to the respective ends of jacket 22, is preferable to control the timing of embossing rollers 3 and 4 with respect to each other as accurately as possible, fitting gears 19 to shaft 13 by means of respective precision couplings, e.g. similar to splined coupling 24, located as close as possible to the respective ends of embossing roller 3, may obviously be sufficient.

1) A method of producing an embossing unit (1) comprising a first and at least one second embossing roller (3, 4) rotating in opposite directions and having first and second outer embossing tips (11, 12) respectively; and at least one drive (18) comprising a first and a second gear (19, 20) angularly integral with the first and second embossing roller (3, 4) respectively; the method being characterized by the steps of forming at least the first embossing roller (3) by covering a core (21) with a cylindrical jacket (22) having the first embossing tips (11) on the outside, and by making the cylindrical jacket (22) integral with the core (21); micrometrically timing the angular position of said first gear (19) and said first embossing tips (11) with respect to each other and with respect to said second gear (20) and to second embossing tips (12) of the second embossing roller (4) so as to obtain substantial meshing of the first and the second embossing tips (11, 12).

2) A method as claimed in claim 1, wherein timing is regulated micrometrically with the aid of precision detecting means (26).

3) A method as claimed in claim 2, wherein said precision detecting means (26) comprise an optical detecting device.

4) A method as claimed in claim 2, wherein said precision detecting means (26) comprise a microscope.

5) A method as claimed in claim 1, wherein the cylindrical jacket (22) and the core (21) are locked angularly to each other with the interposition of a layer of glue (23).

6) A method as claimed in claim 1, wherein the first embossing roller (3) has two opposite axial ends; said first gear (19) being fitted directly to a respective axial end of the first embossing roller (3).

7) A method as claimed in claim 1, wherein the first gear (19) is fitted directly to the cylindrical jacket (22).

8) A method as claimed in claim 7, wherein the cylindrical jacket (22) has two opposite annular end surfaces (28); and the first gear (19) is fitted directly to the cylindrical jacket (22) with the interposition of a further layer of glue (27) between the first gear (19) and the relative annular end surface (28) of the cylindrical jacket (22).

9) A method as claimed in claim 1, wherein the steps of positioning the two embossing rollers (3, 4) tangent to each other along respective pitch surface generating lines; micrometrically adjusting the timing of the two embossing rollers (3, 4) with respect to each other, so as to set the first embossing tips (11) to a meshing position meshing with the second embossing tips (12); locking the two embossing rollers (3, 4) in said meshing position; and assembling said drive (18) so as to fix said timing.

10) A method as claimed in claim 1, wherein the cylindrical jacket (22) is made of ceramic.

11) A method as claimed in claim 1, wherein the angular position of said first and second gear (19, 20) is timed micrometrically with respect to the first and second tips (11, 12).

12) A method as claimed in claim 1, wherein timing is regulated micrometrically rotating at least one of the first and second embossing roller (3, 4) with the aid of a micrometric feed device.

13) An embossing unit obtained according to a method as claimed in claim 1, comprising a first and at least one second embossing roller (3, 4) rotating in opposite directions about a first and a second axis (7, 8) of rotation respectively, and having first and second outer embossing tips (11, 12) respectively; and at least one drive (18) interposed between the embossing rollers (3, 4) and comprising a first and a second gear (19, 20) coaxial with the first and second axis respectively, and angularly integral with the first and second embossing roller (3, 4) respectively; the embossing unit (1) being characterized in that at least the first embossing roller (3) comprises a core (21), and a cylindrical jacket (22) integral with the core (21) and having the first embossing tips (11) on the outside; angular connection of the first gear (19) to the first embossing roller (3) being set micrometrically to time the two embossing rollers (3, 4) with respect to each other, so that the first embossing tips (11) are maintained, in use, in a position substantially meshing with the second embossing tips (12).

14) A unit as claimed in claim 13, wherein a layer of glue (23) is interposed between the cylindrical jacket (22) and the core (21) to secure the cylindrical jacket (22) to the core (21).

15) A unit as claimed in claim 14, wherein the core (21) is cylindrical, and the cylindrical jacket (22) is defined by a cylindrical ceramic sleeve fitted onto the cylindrical core (21) with the interposition of said layer of glue (23).

16) A unit as claimed in claim 13, wherein the first embossing roller (3) has two opposite axial ends, and said first gear (19) is fitted directly to a respective axial end of the first embossing roller (3).

17) A unit as claimed in claim 16, wherein a further layer of glue (27) is interposed between said first gear (19) and the respective axial end of the first embossing roller (3).

18) A unit as claimed in claim 16, wherein the first gear (19) is fitted directly to the cylindrical jacket (22).

19) A unit as claimed in claim 17, wherein the cylindrical jacket (22) has two opposite annular end surfaces (28); said further layer of glue (27) being interposed between the first gear (19) and the relative annular end surface (28) of the cylindrical jacket (22).

20) A unit as claimed in claim 13, and comprising two said drives (18) located on opposite sides of said first and second embossing roller (3, 4), and each comprising a said first and a said second gear (19, 20) coaxial with the first and second axis (7, 8) respectively, and angularly integral with the first and second embossing roller (3, 4) respectively.

21) A unit as claimed in claim 13, wherein the cylindrical jacket (22) is made of ceramic.
